(19) United States
(12) Patent Application Publication
(10) Pub. No.: US 2007/0075509 A1
(43) Pub. Date: Apr. 5, 2007

(54) Stair climbing cart

(76) Inventor: Samuel T. Wyrick III, Cary, NC (US)

Correspondence Address: Samuel T. Wyrick, III, 111 Lions Gate Drive, Cary, NC, 27511, US

(21) Appl. No.: 11/244,381

(22) Filed: Oct. 5, 2005

(51) Int. Cl. B62B 1/00

(52) U.S. Cl. 280/47.27

(57) ABSTRACT

The present invention is directed to a cart for transporting cargo that is capable of climbing stairs. In the preferred embodiment, the cart has two three-wheel assemblies and a frame. The three-wheel assemblies are designed to rotate when contact is made with stairs, thereby allowing the cart to climb the stairs.

### BACKGROUND OF THE INVENTION

1. Field of the Invention

The present invention relates generally to carts for transporting cargo and, more particularly, to carts that can move up and/or down stairs easily.

2. Description of the Prior Art

Typically, utility carts, e.g. dollies, hand trucks, urban grocery carts, beach carts, etc., have two wheels connected by an axel to a frame. The frame typically employs some sort of cargo carrying device—for instance a platform in the case of the dolly or a basket in the case of the grocery cart. These carts help move various types of cargo from one place to another. However, they often have difficulty moving up and down stairs. Often, a user must move the cart's wheels into a step and then pull the cart up to the next step. The carts were not designed to navigate stairways with minimal effort.

To combat these difficulties, prior art devices commonly employs wheels and wheel assemblies having various designs (see, e.g., U.S. Pat. No. 6,224,068; US Published Patent Application No. 2005/0087940). However, none of these devices are designed to minimize a user's efforts to move a cart up and down stairs. To minimize such a user's efforts, a cart's wheel system should not roll substantially on each step, and the cart should move up each step via application of the user's horizontal, and not vertical, force. Further, a cart gains much functionality by adapting it to multiple terrains—e.g. for use as a beach cart—prior art carts are too limited in their utility.

Thus, there remains a need for a cargo transporting cart that can easily navigate stairs and be used on a variety of terrains.

### SUMMARY OF THE INVENTION

The present invention is directed to a cargo-transporting cart that is capable of climbing stairs. In the preferred embodiment, the cart has two three-wheel assemblies and a frame. The three-wheel assemblies are designed to rotate when contact is made with stairs, thereby allowing the cart to climb the stairs. Preferably, the cart is foldable, compact, and has components that provide for the transportation of beach cargo, such as a cooler, chairs, umbrellas, and miscellaneous other items.

Thus, the present invention provides a cart for transporting cargo with at least two three-wheel assemblies that facilitate moving the cart up and down stairs.

Accordingly, one aspect of the present invention is to provide a cart for transporting cargo having at least two three-wheel assemblies and a frame; each three-wheel assembly having three wheels, three arms, and a central rotation point, each wheel having a diameter, and each arm having a length; each wheel is rotatably connected to one arm and each arm is connected to the central rotation point; the frame rotationally holding the three-wheel assemblies near the central rotational point of each assembly, such that the cart is operational to climb stairs through assembly rotation caused by contact with stairs as the cart is moved into the stairs; and the diameter of each wheel is greater than or approximately equal to the length of the arm.

Another aspect of the present invention is to provide a stair climbing cart for climbing at least one set of a lower and upper step, the cart having at least two three-wheel assemblies and a frame; each three-wheel assembly having three wheels, three arms, and a central rotation point, each wheel having a diameter, and each arm having a length; each wheel is rotatably connected to one arm and each arm is connected to the central rotation point; the frame rotationally holding the three-wheel assemblies near the central rotational point of each assembly, and the length of each arm and the diameter of each wheel are selected such that when one wheel is moved into the lower step a second wheel moves to contact the upper step with minimal rolling motion of the second wheel, thereby operating to move the cart up and/or down steps with reduced lifting force.

These and other aspects of the present invention will become apparent to those skilled in the art after a reading of the following description of the preferred embodiment when considered with the drawings.

### BRIEF DESCRIPTION OF THE DRAWINGS

FIG. 1 is a side view of a cart constructed according to the present invention.

FIG. 2 is a front view of a cart constructed according to the present invention.

FIG. 3 is a side view of a cart constructed according to the present invention being moved up a set of stairs.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

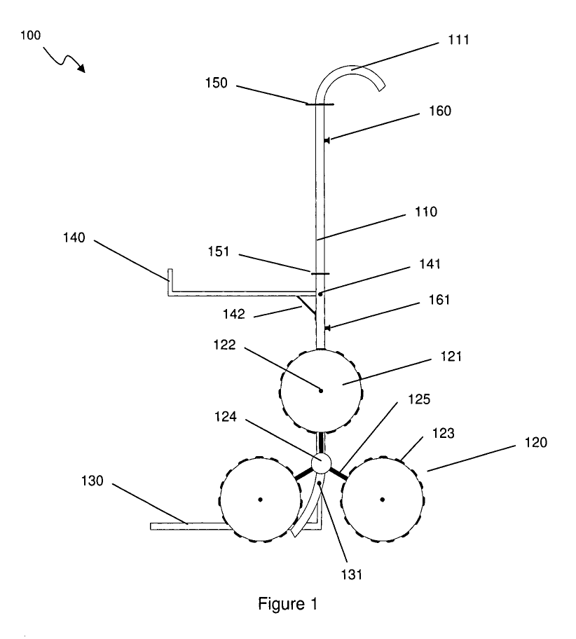

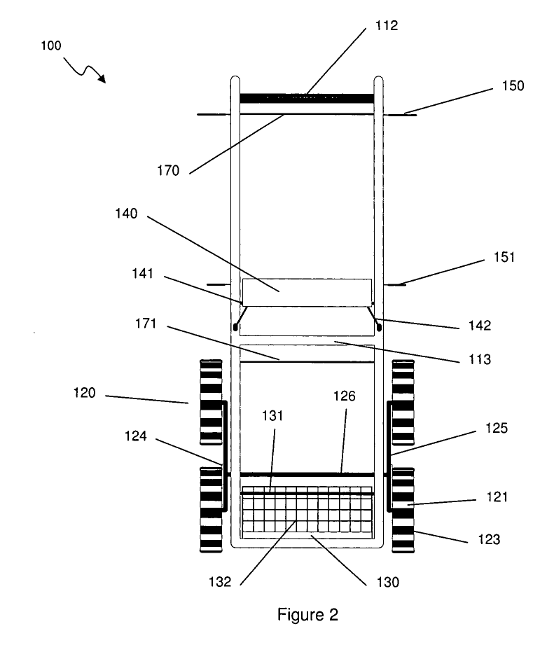

Referring now to the drawings in general, the illustrations are for the purpose of describing a preferred embodiment of the invention and are not intended to limit the invention thereto. As best seen in FIGS. 1 and 2, a cart 100 constructed according to the present invention is shown from the side and front, respectively. Generally, a frame 110 is connected to at least two three-wheel assemblies 120, preferably two three-wheel assemblies.

Frame and Attached Components

The frame 110 is designed to accept a variety of items as cargo and is designed to be easily moved. The frame is preferably made from a metal, such as steel or aluminum, and has a tubular cross-section. Preferably, an aluminum alloy is used to provide strength and minimize weight. However, weld considerations should be taken into account when constructing the frame. Steel welds typically can be as strong as the original material, but aluminum alloy welds are usually not as strong; therefore, the aluminum alloy welds need to be reinforced and/or designed to be sufficiently strong. Alternatively, a mix of steel and aluminum alloy components can be integrated into the frame. For instance, steel may be used for frame areas that may experience high stress during use, such as the areas near the wheel assemblies, and aluminum alloy may be used for areas where stress is not as large a concern. Depending on the materials used, additional frame support may be necessary to ensure its strength and rigidity. Therefore, it is preferable to include at least one frame cross-member 113 to prevent the frame from failing from a twisting or deflecting failure mode. This cross-member may be bowed slightly way from the frame to augment the frame's strength, if necessary.

Preferably, the frame and its accessories should be lightweight, and portable. Additionally, the frame should be sized such that when compacted, it may fit in the back of a station wagon, sport utility vehicle, or truck. Alternatively, the frame may itself be foldable so that it may fit into smaller vehicles. Examples of accessories for the preferred embodiment include umbrella rings 150, 151, bag pegs 160, 161, and utility bars 170, 171.

The umbrella rings are preferably two sets of rings on each side of the cart. Focusing on one side of the cart, there is a large 150 and a small 151 umbrella ring. Preferably the large ring is approximately 4 inches in diameter and the small ring is approximately 2 inches in diameter. A collapsed umbrella, preferably a beach umbrella may be placed through the large and small ring to securely transport the umbrella. The umbrella basically wedges into the lower ring and the upper ring prevents the umbrella from tipping over and out of the lower ring. The umbrella rings are preferably made of plastic and are removable and replaceable via inserts (not shown). The rings may be replaced with other types of accessories, such as fishing rod holders.

There are also four bag pegs 160, 161, two on each side of the frame, facing the user. The pegs preferably hold a cargo net bag that may subsequently hold a variety of miscellaneous items, such as towels and other beach equipment. The utility bars 170, 171 are secured to the frame and are preferably made of metal. These bars allow hooked objects to be secured to them. For instance, bungee cords may be hooked to the bars and used to secure additional items, as discussed below.

To facilitate use, the frame has a curved top 111 that connects to a handle bar 112. The bar 112 is curved away from the frame 110 to enable the user to tip the device without the cart's cargo, which may be taller than the frame (e.g. beach umbrellas), from contacting or interfering with the user. Preferably, the handle bar is also coated with a rubberized or polyurethane coating to provide a grip and cushion to the user.

The heaviest cargo that the cart will carry is likely a cooler (not shown). To carry a cooler, a lower platform 130 is attached to the bottom of the frame 110 via a lower platform hinge 131. The lower part of the frame 110 is curved slightly toward the lower platform such that its lowest crossbar prevents the platform from rotating behind its final resting possession (approximately horizontal when the cart is not in use), as shown in FIGS. 1 and 2. The lower platform is made from plastic and has a grated surface 132. The grated surface allows water and other particles to fall through the lower platform. Preferably, the lower platform has a lip that is approximately 0.25 inches deep to keep a cooler from falling off the platform. Additionally, a bungee cord or cords attached to the lower utility bar 171 may be used to further secure the cooler. To make the cart as compact as possible for storage/vehicular transportation, the lower platform is foldable via the hinge 131.

To accommodate more cargo and maximize use of the frame's size, an upper platform 140 is preferably attached to the frame above the lower platform 130 via an upper platform hinge 141. The upper platform is designed to hold folding chairs, such as beach chairs. Preferably, the upper platform is sized to hold at least four chairs. This platform is also made from plastic, as is the lower platform, and has a vertical protrusion, or lip, at its end that helps secure the chairs. Preferably, the upper platform folds upwards via the upper platform hinge 141, similar to the lower platform. Alternatively, the upper platform is releasably attached to the frame via inserts that snap into recesses in the frame. This alternative embodiment allows the complete removal of the upper platform when it is not needed. In either embodiment, upper platform supports 142 are necessary to prevent the upper platform 140 from extending beyond its approximately horizontal orientation (shown in FIGS. 1 and 2). These supports are ideally made of plastic and have pads or expanded ends that interface with the frame to prevent slippage of the supports on the frame. In this manner, the upper platform is designed to maintain a proper cargo-carrying position without substantially deflecting. Additionally, a bungee cord or cords attached to the upper utility bar 170 may be used to further secure the chairs or other cargo that is carried by the upper platform.

According to the preferred embodiment of the present invention, the frame 110 is generally vertical when in a resting position, as shown in FIGS. 1 and 2 (except for the top and bottom, which are slightly curved). However, the frame may be alternatively angled when resting such that the bottom is further from the three-wheel assemblies than in the preferred embodiment. Angling the frame away from the three-wheel assemblies allows the cart's lower platform to accept loads wider than the lower platform's width.

Three-Wheel Assemblies

Near the bottom of the cart, attached to the frame, are preferably two three-wheel assemblies. These permit the cart to be moveable over a variety of terrains and obstacles, as discussed below. Each three-wheel assembly is connected to the frame 110 via a main axel 126 that spans the width of the frame and attaches to both three-wheel assemblies 120. The axel is mounted in the frame using bearings that are inserted into holes in the frame (not shown). Preferably, these bearings are sealed and selected to be operable in a sandy environment, where particulates could pose a problem if they were to enter the bearing's internal components. The main axel 126 is made from a durable, strong, and lightweight material—preferably a metal such as steel or aluminum alloy. By connecting the three-wheel assemblies to each other via the main axel, congruent rotation of the assemblies is provided when moving up or down stairs, as described below.

Each three-wheel assembly is preferably symmetrical to the other. Focusing now on one three-wheel assembly, the axel 126 is connected to a central hub 124. The central hub is located at or near the geometric center of the three-wheel assembly 120, when viewed from the side, as seen in FIG. 1. The central hub may be made from the same material as the main axel to facilitate welding of the axel to a hub. However, it is preferable to use a releasable attachment such that the three-wheel assemblies can be easily mounted and dismounted from the cart if necessary. This facilitates initial assembly and future repairs. The releasable attachment is preferably a bolt or similar component. Thus, the central hub preferably has a bolt hole that runs through it and connects the hub to the main axel that has complementary mating threads for the bolt along the axel's longitudinal axis. A protective/decorative cover preferably goes over the bolt to hide it from sight and prevent corrosion.

Connected to the central hub 124 are three arms 125 that are equally spaced around the central point of the hub. Thus, in the preferred embodiment, each arm is separated from the other arms by approximately 120 degrees, as seen in FIG. 1. The arms are preferably made from metal, such as steel or aluminum alloy. They are welded to each other at the central hub 124.

The end of each arm 125, furthest from the central hub 124, bends or curves away from the frame 110 and terminates into a wheel axel 122 that provides a pivotable connection for a wheel 121. Preferably, the arms are approximately 7 inches in length from the center of the central hub 124 to the wheel axel 122.

The wheels are designed to handle a variety of terrains. Preferably, they are adapted to traverse sand, boardwalks, and rocky terrain. Therefore, the exterior of the wheels 121 are made of a hard rubber, have large treads 123 (raised approximately 0.25 inches out from the wheel) and are approximately seven inches in diameter and two to three inches wide to provide optimal traction on the aforementioned terrains and prevent a wheel from becoming stuck in a rut or gap in a boardwalk. The interior portions of the wheels are preferably made of a strong, durable plastic material to provide a lightweight, robust wheel. Further, the plastic wheels can rotate directly on the metal wheel axel without a bearing. Alternatively, the wheels may incorporate an inflatable tire around them such that the cart can be used in shallow water or to better navigate solid outdoor surfaces, such as concrete/asphalt.

Example of the Present Invention in Use

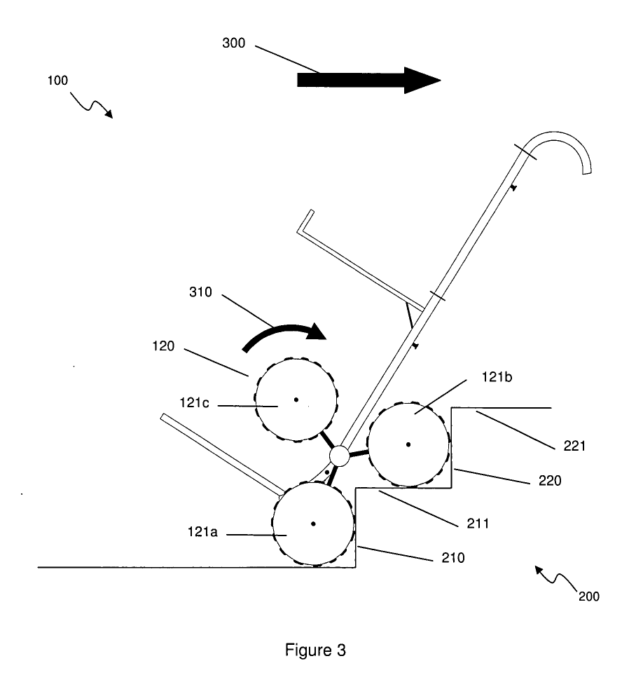

The three-wheel assemblies are designed to rotate when contact is made with stairs, thereby allowing the cart to climb the stairs. An example of the present invention in use is shown in FIG. 3. The cart 100 is tipped toward the handle bar (toward the right side of the figure) by a user and moved toward a set of stairs 200, in the direction of the horizontal arrow 300. To facilitate discussion, the two steps of the stairs (generally referred to as the first and second step) are each segmented into a vertical face 210, 220 and a horizontal face 211, 221.

When the user starts his or her ascent up the stair case, a first wheel 121a of each three-wheel assembly 120 makes contact with the vertical face of the first step 210. This causes the first wheel 121a to stop moving and serve as a pivot point for the three-wheel assembly 120. The user continues horizontally pulling the cart in the direction of the horizontal arrow 300. Subsequently, the three wheel assembly rotates about the central hub/main axel in the direction of the rotational arrow 310 (clockwise in FIG. 3). Because the components of the three-wheel assembly are properly sized and selected, the second wheel 121b makes simultaneous contact with both the horizontal 220 and the vertical 221 faces of the second step. Therefore, the second wheel 121b is almost immediately stopped rolling by the vertical face of the second step 220 and thus serves as a new pivot point for the three-wheel assembly. The third wheel 121c then rotates onto the horizontal face of the second step 221. The forgoing motions are repeated until the cart and its three-wheel assemblies have cleared the stairs. Additionally, the two three-wheel assemblies rotate in unison because they are connected via the main axel. This prevents the three-wheel assemblies from becoming unsynchronized and maintains a smooth climbing motion.

Reversing motion, the three-wheel assemblies will move down a set of stairs slightly differently. Preferably, the cart is moved toward a descending set of stairs and two of the wheels “see-saw” back and forth down the steps. This occurs because the first wheel will not be stopped by a vertical face, as occurs when the cart is moving up a set of stairs. However, the present invention provides relatively smooth downward motion for the cart because the three-wheel assemblies are sized to always have two wheels simultaneously contacting two steps. Therefore, the cart is stably moved down stairs because there are always four wheels (two on each side) in contact with the stairs, as opposed to two in the prior art. Further, a user can pause at almost any point because the wheels are sized so that two horizontal step faces may be contacted by two wheels at the same time.

Alternatively, a brake system can be added to the wheels to facilitate moving the cart down stairs. This could be operated as a hand-break or similar setup attached to the handle bar. The lower wheel would then act as a pivot point for the system and the top wheel would rotate downwards. If a brake is used in this manner, the locking mechanism can be implemented to lock the brake so the user will not have to constantly apply pressure to maintain braking force.

The sizing of the arm lengths and wheel diameters are important to move the cart up and down stairs, as explained above. The dimensions were found as follows. Referring briefly to FIG. 3, the “depth” of a step is represented by the length of a horizontal face of a step 210, 220, and the “height” of a step is represented by the length of a vertical face of a step 211, 221. As a design example, an average stair size may be approximately 10 inches deep and 7 inches high. Preferably, the length of each arm and the diameter of each wheel are selected such that when one wheel is moved into the lower step a second wheel moves to contact the upper step with minimal rolling motion of the second wheel, thereby operating to move the cart up and/or down steps with reduced lifting force. Therefore, the geometric solution to this problem yields an arm length of 7.05 inches when the wheel diameter is 7 inches. Generally, the wheel diameter-to-arm length is relatively large compared to prior art stair navigation apparatuses. These dimensions are for an average set of outdoor stairs and can be further optimized for stairs of different dimensions. Regardless, to maintain ease of moving the cart up and down stairs by providing a sufficient leverage and rolling efficiency, the wheels should be approximately equal to or larger than an arm length.

### ALTERNATIVE EMBODIMENTS

The present invention is preferably directed to a beach cart for transporting beach cargo. However, the basic construct contained in the cart is not limited to use in the beach cart described. The construct, in elemental form, may be universally adapted in all hand cart applications, for moving loads on stairs and varied terrains in commercial and residential contexts. The permutations of usage, within the universe of hand trucks, are limitless.

One such permutation would be to modify the present invention to carry urban cargo. In this urban utility cart, the cart of the present invention is adapted for carrying groceries, laundry, etc. Overall, the urban utility cart is shorter than the cart described above, as it no longer has the upper platform; preferably, it is two-thirds as tall. In place of the lower platform is a basket that is rectangular in shape, made of metal wire, open at the top, and approaches the top of the frame; thus, the basket occupies most of the frame's carrying capacity, preferably, the basket's height is two-thirds of the frame's length.

When needed, a basket container insert can be removably placed inside the basket. It is also rectangular in cross section and is made of plastic. It may be effectively sealed via a plastic top that is attached via a hinge to or completely removable from the container insert. The top makes the container insert water resistant or water proof to provide for transporting good or materials in adverse weather by keeping the items dry. The container insert also extends the functionality of the cart by enabling transport of material that would otherwise fall through the basket because the material contains particulates or small parts.

Certain modifications and improvements will occur to those skilled in the art upon a reading of the foregoing description. By way of example, the frame of the cart can be the frame of an infant or child's stroller with two or four of the stroller's regular wheels substituted for the three-wheel assemblies of the present invention; thus the present invention can be readily adaptable as a stroller, among other things. All modifications and improvements have been deleted herein for the sake of conciseness and readability but are properly within the scope of the following claims.

What is claimed is:

1. A cart for transporting cargo comprising:
a. at least two three-wheel assemblies
b. a frame;
c. wherein each three-wheel assembly comprises three wheels, three arms, and a central rotation point, each wheel having a diameter, and each arm having a length;
d. wherein each wheel is rotatably connected to one arm and each arm is connected to the central rotational point;
e. wherein the frame rotationally holds the three-wheel assemblies near the central rotational point of each assembly, such that the cart is operational to climb stairs through assembly rotation caused by contact with stairs as the cart is moved into the stairs;
f. wherein the diameter of each wheel is greater than or approximately equal to the length of the arm.

2. The cart of claim 1, wherein at least one platform is attached to the frame for carrying at least one item.

3. The cart of claim 2, wherein, the at least one platform is foldable.

4. The cart of claim 2, wherein the at least one platform comprises a lower and an upper platform.

5. The cart of claim 3, wherein the lower platform is adapted to hold a cooler.

6. The cart of claim 3, wherein the upper platform is adapted to hold foldable chairs.

7. The cart of claim 3, wherein the upper platform is removable from the frame.

8. The cart of claim 1, wherein the wheels are selected from the group consisting of wheels adapted for water, wheels adapted for sand, rubber wheels, and ridged wheels.

9. The cart of claim 1, wherein the three-wheel assemblies are rotatably connected to the frame by an axel.

10. The cart of claim 1, wherein the frame is foldable to compact its size.

11. The cart of claim 1, wherein at least one umbrella holding device is attached to the frame.

12. The cart of claim 1, wherein at least one bag is attached to the frame.

13. The cart of claim 1, wherein a handle bar is attached to the frame.

14. The cart of claim 1, wherein a basket is attached to the frame for carrying at least one item.

15. The cart of claim 14, wherein the basket is fitted to accept an removable container.

16. The cart of claim 15, wherein a moveable top covers the removable container.

17. The cart of claim 15, wherein the removable container and top are water resistant or water proof.

18. The cart of claim 15, wherein the top is hingeably connected to the removeable container.

19. A stair climbing cart for climbing at least one lower step and at least one upper step comprising:
a. at least two three-wheel assemblies
b. a frame;
c. wherein each three-wheel assembly comprises three wheels, three arms, and a central rotation point, each wheel having a diameter, and each arm having a length;
d. wherein each wheel is rotatably connected to one arm and each arm is connected to the central rotational point;
e. wherein the frame rotationally holds the three-wheel assemblies near the central rotational point of each assembly.
f. wherein the length of each arm and the diameter of each wheel are selected such that when one wheel is moved into the lower step, a second wheel moves to contact the upper step with minimal rolling motion of the second wheel, thereby operating to move the cart up and/or down the steps with reduced lifting force.
